(19) United States
(12) Patent Application Publication
(10) Pub. No.: US 2001/0033297 A1
(43) Pub. Date: Oct. 25, 2001

(54) Internet conduit providing a safe and secure environment

(76) Inventors: Venkatram R. Shastri, Randolph, MA (US); Caroline B. Faris, Westborough, MA (US); Robert S. Langer, Newton, MA (US)

Correspondence Address: Choate, Hall & Stewart, Exchange Place, 53 State Street, Boston, MA, 02109, US

(21) Appl. No.: 09/789,955

(22) Filed: Feb. 21, 2001

Related U.S. Application Data
(60) Provisional application No. 60/183,860, filed on Feb. 22, 2000.

(51) Int. Cl. G06F 3/00; G06F 13/00

(52) U.S. Cl. 345/741; 345/854

(57) ABSTRACT

Navigation tool for Internet or intranet. A specialized server includes different browsing levels appropriate for different age groups. The browser will thus prevent users from accessing inappropriate web pagers.

This application claims benefit of provisional application Ser. No. 60/183,860, filed Feb. 22, 2000.

### BACKGROUND OF THE INVENTION

The present invention is an Internet conduit and, more particularly, an Internet conduit implemented on a novel server to provide a safe and secure environment for children and young adults.

It is well known that children and young adults can gain access to Internet sites full of profanity and inappropriate sexual content. In addition, it is known that on-line services and bulletin boards are quickly becoming the most powerful resources used by predators to identify and contact children. Further, a recent survey has found that the most potentially serious safety concern on the Internet is presented by the posting of personal identifying information by and about children in interactive public areas such as chat rooms and bulletin boards that are accessible to all on-line users.

Interactive public areas on the Internet are inherently unsecured and allow for exchange of information with minimum verification. On Apr. 20, 1999 the United States Government moved to enforce a new law that bans companies from collecting personal information from children on-line without their parents' permission. Consistent with this move, the Federal Trade Commission proposed rules that would require e-commerce entities to seek parental consent prior to requesting personal and contact information from children under the age of 13. Although the children's on-line privacy protection act passed by the United States Congress last year mandates the requirement of parental consent before seeking information from children, e-commerce entities have little idea of how to get such consent.

There are several approaches to providing custom on-line content for children, including Junior Net, Kids Domain, Zap Me!, and Disney Blast among others. However, none of these providers has created a virtual private network that also offers access to selected, and approved, sites on the Internet. These prior art systems are either entirely limited to proprietary content or are public portals which grant children access to the entire Internet. There is therefore a need for a system to ensure maximum accessibility to the Internet with substantially zero exposure to inappropriate content, including content that can seriously compromise the safety of children and young adults.

### SUMMARY OF THE INVENTION

The navigation tool for the Internet or an intranet according to the invention comprises a server, the tool including:

different browsing levels,

means to restrict access to the Internet or intranet on demand, and

means to change the tool in both appearance and features on demand, whereby access is controlled and modified by a combination of active and passive authentification, verification, and security algorithms and protocols.

In a preferred embodiment, the navigation tool includes a modified Netscape® Navigator browser, or a modified Microsoft® Internet Explorer browser. In another embodiment, the navigation tool of the invention is compatible with the Linux Operating System, Macintosh Operating System, Sun Operating System or Operating Systems developed using Java or Unix languages.

The navigational tool of the invention will thus provide an Internet conduit that is a safe and secure environment, free of profanity and sexual content, using the unique, specialized server. This conduit will serve as a medium for both education and recreation for children and young adults (one month to 14 years). The technology can be used to create vibrant, thriving local communities, with emphasis on participation of the whole family unit, providing in turn the building blocks for the creation of a global community. The approach of the invention will draw upon the strength of geographical commonality to form strong local communities that encourage the participation of the family and is inclusive of kids and young adults of differing race, language and religious beliefs.

The technology disclosed herein will become a strong force and symbol in family education, and families will want to become a part of that network. The core of the network and many of its services will be centered on and around the local community, and the strength of the technology will be global and will promote focused interaction globally among users of the technology. In that sense, these local communities will naturally evolve into a true global network of communities that transcend international boundaries. The navigation tool of the invention will facilitate the true globalization of the Internet by providing a space in the virtual world that is free of constraints and pre-conceptions where the future of our world, i.e., the kids and young adults, can congregate. The formation of local communities as the basic building block will allow for a much more effective dissemination of educational and other informative content than prior art systems.

The present navigation tool may be embodied as a premium Internet subscription service for children and young adults with an emphasis on the participation of the family in the creation of local communities. A monthly fee of, for example, $9.95, will be charged for unrestricted access to sites certified by the proprietor of the navigation tool of the invention. The technology includes custom browsers with proprietary interfacing technology that will allow for easy restriction of content for children while allowing complete access to the Internet by parents.

In another aspect, the navigation tool of the invention includes dual-usage browser interface technology that will allow for the dual-usage of the browser by both children and adults which allows the adult to morph. the browser to its full accessibility with concurrent access to personal e-mail at the click of a mouse. This feature is password activated and will automatically deactivate after a fixed period restoring the browser to its secure morphology. The security between the specialized server of the invention and the web site hosting the technology will be ensured by advanced security protocols to enable unrestricted global access.

In another aspect, the navigation tool includes selectively disabling hyperlinks on a web page based on their content and security status maintained within a database of certified content providers.

The present invention is the only system known to the inventors that creates a virtual private network that also offers access to selected sites on the Internet which are safe and secure. The system of the invention will create a virtual town hall, commons, and informal market place in which people can gather, exchange services (such as nannies and day-care), and organize local children-related events.

### BRIEF DESCRIPTION OF THE DRAWINGS

FIG. 1 is a block diagram illustrating one aspect of the present invention.

FIG. 2 is a block diagram illustrating another aspect of the present invention.

### DESCRIPTION OF THE PREFERRED EMBODIMENT

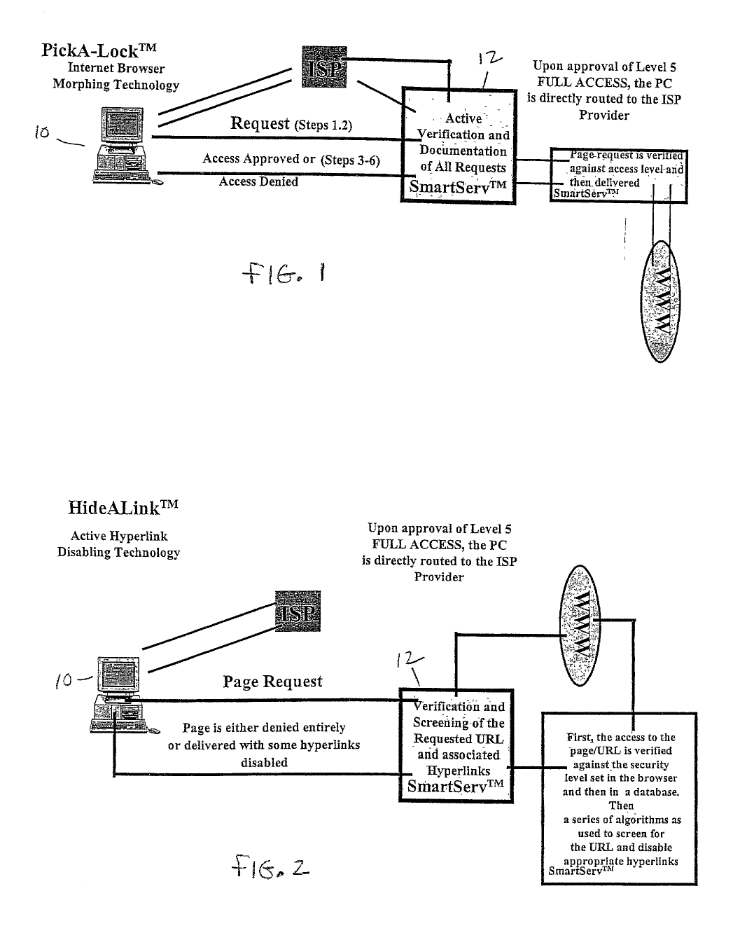

The present invention provides an Internet conduit using a unique server that is a safe and secure environment free of profanity and sexual content, which will serve as a medium of both education and recreation for children and young adults. With reference to FIG. 1, a user (not shown) types in a password at a personal computer 10 and requests a level of access ranging from, for example, levels 1-5. For instance, level 1 may be appropriate for a child up to 4 years of age; level 2 for a child 4-7 years of age; level 3, 7-10 years of age and level 4, 10-14 years of age. Level 5 is full access with or without automatic default to a secure mode/format. The password may be alphanumeric, voice, visual, fingerprint, information stored on an insertable storage medium, or in an insertable microchip. The personal computer 10 sends the request to a server 12 referred to as SmartServe™. There is exchange of information (e.g., cookie, token, or specific code installed in the PC 10 during the installation of the browser of the invention).

Active verification and authentication of the request is performed and also uploading of necessary files and activation of dormant files on the personal computer 10 to override security features. The navigation tool of the invention may be changed so as to alter both access, features and icons (appearance) to a fully accessible form which will be accompanied by simultaneous access to e-mail ( AOL, MSM) of the parent or adult of the home and also default to a pre-requested page such as, for example, Yahoo. In the level 1-4 mode the browser will block download of files and other material from the World Wide Web that are not certified to the Smart Serve™ server 12. The technology will prevent overwriting of the loaded browser thus preventing unauthorized modification. The browser of the invention can be installed or reinstalled only while being online upon active verification by the server 12. If the PC 10 idles for a set time period the browser will change back to the secure mode/format. In essence, the server 12 will act as a Proxy server.

The active hyperlink disabling technology of the invention (referred to as Hide-A-Link™) will now be described in conjunction with FIG. 2. When the PC 10 requests a page, the page is either denied entirely or delivered with some hyperlinks disabled. In particular, access to the page/URL is verified against the security level set in the browser and in a data base as discussed above in conjunction with FIG. 1. Thereafter, a series of algorithms are used to screen for the URL and to disable appropriate hyperlinks, i e., hyperlinks to sites which would include undesirable content. In the case that a requested page is denied entirely, the user is redirected to a URL or other page of interest. This aspect is achieved by monitoring the pattern of browsing by the user using technologies such as collaborative filtering.

The browser of the invention features different levels of restrictive interface depending on age and user preferences which may be customized. Complete access is linked to an adult's e-mail. By using the same password, files and folders containing material not suitable to viewing by children may be secured.

The six million children (age 6-12) on-line in America today are expected to grow to 13 million by 2003. On-line services for this group are currently fragmented, with no true national or global leader. Moreover, all of the current services are incomplete in their offerings. The navigation tool of the invention meets a number of unmet needs in demand by this segment by offering the following as one package;

Educational content. While many companies are vying for kids' attention on-line by promoting existing products and services, Forrester Research shows that kids have a “clear preference for content—games, communications, and creativity” over commerce. Developing this type of interactive content is core to the technology disclosed herein.

Safe, secure, and privacy-rich online environment. Currently many families would like to enable their children to better utilize the Internet but are unwilling to give up privacy for content and are uncomfortable with the risks inherent in that unmonitored environment. The system will address these concerns by creating a wholly safe and private environment.

Services that promote family interaction. While this service is primarily focused on children, it will offer a host of services directed towards the entire family, including parents, and community. In this way, the system will be valued by the entire family.

What is claimed is:

1. A navigation tool for the Internet or intranet comprising:
a specialized server including:
different browsing levels;
means to restrict access to the Internet or intranet on demand; and
means to change the navigation tool in both appearance and features on demand, whereby access is controlled and modified by a combination of both active and passive authentication, verification, and security algorithms and protocols.

2. The navigation tool of claim 1 comprising a modified Netscape® navigator browser.

3. The navigation tool of claim 1 comprising a modified Microsoft® Internet explorer browser.

4. The navigation tool of claim 1 adapted to be compatible with Linux operating system.

5. The navigation tool of claim 1 adapted to be compatible with any operating system.
